(19) United States
(12) Patent Application Publication
(10) Pub. No.: US 2025/0131640 A1
(43) Pub. Date: Apr. 24, 2025

(54) Intersection Testing on Dense Geometry Data using Triangle Prefiltering

(71) Applicant: Advanced Micro Devices, Inc., Santa Clara, CA (US)

(72) Inventors: Joshua David Barczak, Forest Hill, MD (US); Mohammed Ahmed Muneam Al-Obaidi, St. Albans (GB); David Kirk McAllister, Holladay, UT (US); Andrew Erin Kensler, Seattle, WA (US)

(21) Appl. No.: 18/742,830

(22) Filed: Jun. 13, 2024

Related U.S. Application Data
(60) Provisional application No. 63/591,946, filed on Oct. 20, 2023.

(51) Int. Cl. G06T 15/06

(52) U.S. Cl. CPC G06T 15/06; G06T 2210/12; G06T 2210/21; G06T 2210/52

(57) ABSTRACT

Systems and methods for ray intersection against primitives are described. Primitive data is encoded efficiently into arrays of fixed-size data blocks using a data format which can be directly consumed for ray traversal. Vertex data in a block is pre-quantized and stored using a fixed-bit quantization grid. Mesh connectivity is encoded using a triangle strips based on control values representing triangle interconnectivity, and a compressed index buffer storing indices for vertices in each strip. Primitives can alternatively be quantized to generate primitive packets, that are stored compactly in, with, or near a leaf node of an acceleration structure. Low-precision intersection testers test a ray simultaneously against primitives to find candidate triangles that require full-precision intersection. Primitives that generate an inconclusive result during low-precision testing are retested using full-precision testers to definitively determine ray-triangle hits or misses.

### CROSS REFERENCE TO RELATED APPLICATIONS

This application claims priority to Provisional Patent Application Ser. No. 63/591,946, entitled “Intersection Testing on Dense Geometry Data using Triangle Prefiltering” filed Oct. 20, 2023, the entirety of which is incorporated herein by reference.

### BACKGROUND

### Description of the Related Art

Ray tracing involves simulating how light moves through a scene using a physical rendering approach. Although it has been extensively used in cinematic rendering, it was previously deemed too demanding for real-time applications until recently. A critical aspect of ray tracing is the computation of visibility for ray-scene intersections, achieved through a process called “ray traversal.” This involves calculating intersections between rays and scene objects by navigating through and intersecting nodes organized in an acceleration structure such as a bounding volume hierarchy (BVH).

Standard methods for performing ray tracing operations usually involve executing a graphics processing pipeline consisting of a series of stages dedicated to graphics operations. For instance, during each stage of this pipeline, a GPU can carry out various graphics-oriented processing tasks. At one stage, the GPU might gather a collection of geometrical primitives that depict a graphics scene, and in a subsequent stage, it could execute shading operations using the vertices linked to those primitives. Ultimately, the GPU would convert these vertices into pixels through a process known as rasterization, thereby rendering the graphics scene.

For every graphics primitive or geometry object created, identifying where rays intersect with the geometry in a scene involves a significant amount of computational effort. One simplistic approach involves testing each ray against every primitive in the scene and then determining the closest intersection point among them. However, this method becomes impractical for scenes with millions or billions of primitives, especially when the number of rays to be processed is also high. To address this, ray tracing systems typically employ acceleration structures to characterize the scene's geometry in a way that reduces the workload for intersection testing. Despite advancements in these acceleration structures, achieving real-time intersection testing suitable for rendering images, especially for gaming applications, remains challenging. This challenge is particularly pronounced on devices like smartphones, tablets, and laptops, which have strict limitations on silicon area, cost, and power consumption.

Further, in various scenarios, for intersection testing primitives against a ray, multiple redundant copies of primitive data needs to be maintained. This practice becomes problematic due to the potentially large number of primitives present in a typical graphics scene, which could number in the millions. As a result, a conventional ray tracing system might end up storing millions of duplicate data copies. Handling such redundant data consumes computational resources inefficiently and can impede the rendering speed of a graphics scene.

In view of the above, improved systems and methods for encoding primitive data for intersection testing against rays are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 a block diagram illustrating compression of primitive data using prefilter nodes.

FIG. 4 illustrates a Dense Geometry Format (DGF) block for storing encoded primitive data.

FIG. 5 is a block diagram illustrating ray testing using compressed primitive data.

FIG. 6 illustrates a node decompressor for decoding encoded triangle data stored within DGF nodes and/or prefilter nodes.

FIG. 7 illustrates a method of decoding primitive data for intersection testing of primitives against rays.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for encoding primitive data for use in intersection testing are disclosed herein. The primitive data is encoded efficiently into fixed-size data blocks. In an implementation, these blocks can be directly consumed by processing circuitry (e.g., GPU) for ray traversal. To create the data blocks, vertex data is encoded using a signed fixed-point grid. As described herein, “a fixed-point grid” is taken to mean a representation of triangle vertices and other geometric entities using fixed-point coordinates rather than floating-point values. The fixed-point grid, in one implementation, can be used due to their lower memory requirements and faster processing speed. A signed fixed-point grid divides a coordinate space (e.g., 2D plane or 3D space) into a grid of fixed-size cells or bins. Each vertex of a triangle is quantized by mapping its floating-point position to a grid cell within the fixed-point coordinate space. The floating-point position is multiplied by a scaling factor (e.g., power of two scaling factor) to convert it into a fixed-point value. For each vertex of a triangle (or other geometric primitive), its position is quantized to a grid cell using the fixed-point representation. The quantized grid cell serves as an approximation of the original floating-point position. In an implementation, data corresponding to quantization of vertices includes a 24 bit signed base position in the grid. A variable-width (e.g., 1-16 bits) unsigned offset for each vertex (relative to the base position) is also stored. Finally, a power-of-2 scale factor, used to map the quantization grid to floating-point coordinates for each triangle vertex, is stored as an “IEEE biased exponent.”

In one implementation, encoded vertex data and other triangle data is stored as part of primitive mesh(es) data. The primitive mesh data includes a set of vertices, where each vertex is defined by its position (e.g., in a three-dimensional space) and additional attributes like normal vectors (vectors normal to an object), texture coordinates, or colors. The mesh is composed of primitives, where each primitive is defined by indices pointing to the vertex data. For example, triangle meshes are often stored using optimized data structures like bounding volume hierarchies (BVHs) or k-dimensional trees (KD-trees). These structures organize the triangles spatially to accelerate ray-triangle intersection tests.

In one implementation, mesh connectivity data is encoded using primitive strips (e.g., triangle strips), and an index buffer. Primitive strips are used to describe and render a continuous surface or object composed of primitives. In a primitive strip, each primitive shares an edge with the previous primitive in the sequence. This shared edge is formed by two consecutive vertices in the vertex list. In one implementation, by sharing vertices between adjacent primitives, primitive strips require fewer vertex data compared to individual primitive data, which reduces memory consumption and improves rendering performance.

In one or more implementations, the index buffer includes a fixed number of control values for primitives in the primitive strip. Each control value is indicative of the primitive's position relative to previously identified triangles in the strip. In an implementation, the length (or size) of the index buffer is determined based on the contents of the control values. The index buffer includes a set of bits, wherein each bit corresponds to an index of a given vertex of a primitive. The index buffer is organized into two parts. The first parts includes an array of bits, storing one bit per vertex indicative of whether a first index to a given vertex is encountered (hereinafter “first index”). The second part includes ‘N’ bits per index to store each non-first index to a vertex (hereinafter “non-first index”), wherein the value of N is predefined, and the value of N is stored at the data block header. In an implementation, the index buffer is compressed by re-ordering the vertices by first use and omitting storage of the first index corresponding to every vertex (this index can be computed by incrementing a counter).

In one implementation, a primitive identifier can be derived from the primitive's position in the strip, and therefore does not need to be stored explicitly in the data block, further reducing memory usage. In another implementation, the data blocks further include encoded geometry identifiers. These can be encoded in two modes referred to as a “constant mode” and a “palette mode.” In constant mode encoding, a geometry ID field in the data block stores a geometry ID and an opaque flag (indicating whether a triangle is opaque or transparent to incoming rays of light) that apply to all triangles. In palette mode, the geometry ID field is interpreted based on least significant bits (LSB) and most significant bits (MSB).

As described herein, a ray tracing system uses multiple low-precision intersection testers in parallel to determine candidate nodes to traverse in an acceleration structure. Geometric primitive data is stored using either data blocks as described above and/or are quantized to generate prefilter nodes that are stored compactly at or near leaf nodes of the acceleration structure. In an implementation, when a given acceleration structure is built, ray tracing circuitry is configured to pre-quantize a group of primitives and store them compactly (e.g., in a compressed format) within a given node of the structure (e.g., as nodes generated between internal nodes and leaf nodes of a BVH). These nodes are hereinafter referred to as “prefilter nodes.” Further, low-precision intersection testers test a ray simultaneously against a plurality of primitives based on data decoded from the data blocks and/or the prefilter nodes, to find candidate primitives that require full-precision intersection. Primitives that generate an inconclusive result during low-precision testing are retested using full-precision testers to determine ray-triangle hits or misses. Testing the primitives simultaneously (i.e., in parallel) using low-precision testers speeds culling of instances that do not require full-precision testing. As described herein, a conclusive intersection result or a conclusive test result is taken to mean that a ray-object intersection test definitively determines whether the ray intersects an object and, if so, at what point. Conversely, an inconclusive test result is taken to mean that a ray intersection test could not definitively determine whether the ray intersects the object. In one implementation, test results can be deemed as conclusive or inconclusive based on how a ray intersects an object with respect to a boundary formed by the object. In another implementation, an intersection plane can be created around each object and ray intersections or misses with respect to the intersection plane can be used to determine if a ray conclusively hits the object, conclusively misses the object, or if the intersection test is inconclusive. Other implementations are contemplated. Hereinafter, terms “low-precision” and “reduced-precision” are used interchangeably until otherwise specified. Similarly, terms “full-precision” or “high-precision” are used interchangeably until otherwise specified.

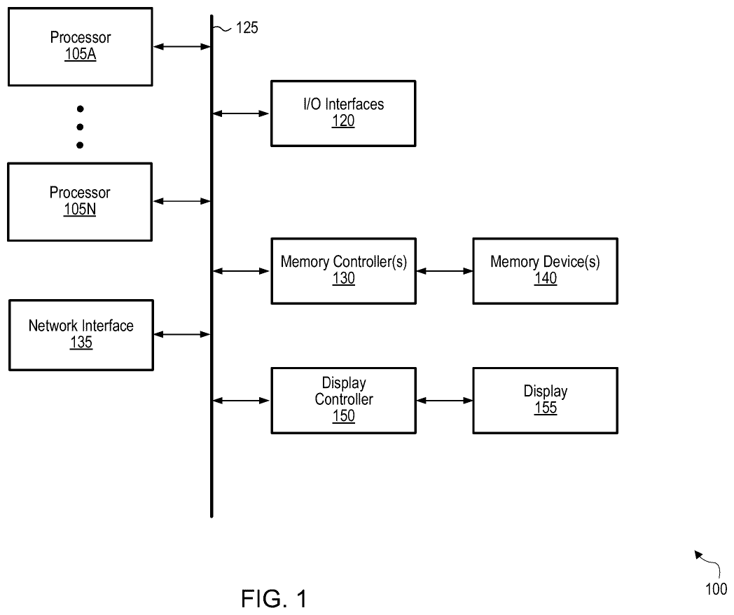

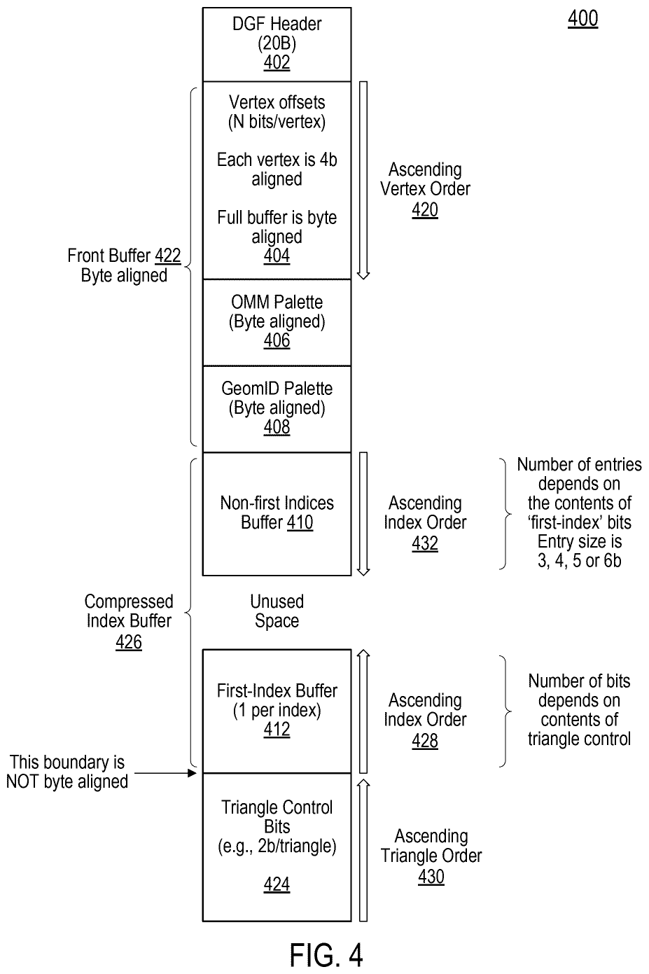

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-8 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

As used hereinafter “intersection testers,” “intersection testing filters,” or simply “testers” refer to specialized hardware components that include circuitry configured to perform ray tracing calculations in graphics rendering. In various implementations, these components include ray tracing (RT) cores and tensor cores. RT cores include dedicated hardware circuitry specifically designed for ray tracing calculations. They are responsible for performing ray-object intersection tests for determining how light interacts with objects in a scene. Further, tensor cores include specialized hardware used to accelerate certain aspects of ray tracing and other machine learning workloads. In implementations described herein, low-precision (or reduced-precision) intersection testing filters are configured to perform ray intersection tests with quantized (reduced) precision objects, such as triangles. Similarly, full-precision intersection testing filters are configured to perform ray intersection tests with high (or full) precision computations.

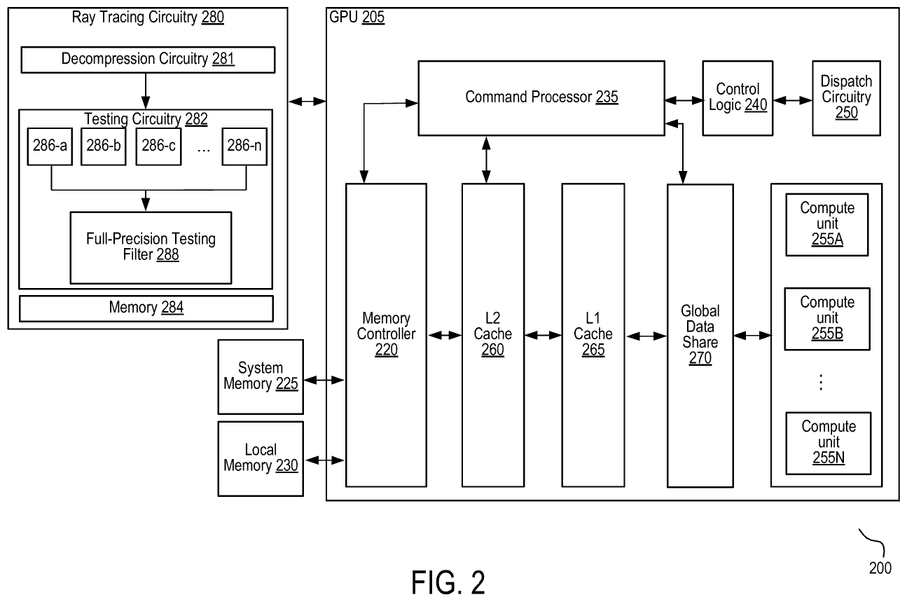

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing circuitry 280 at least including a node decompression circuitry 281, testing circuitry 282, and memory 284.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N. As described below, certain types of circuits are referred to as “units” (e.g., a decode unit, compute unit, an arithmetic logic unit, functional unit, memory management unit, etc.). Accordingly, the term “unit” or “units” also refers to circuits or circuitry unless otherwise indicated.

As shown in the figure, ray tracing circuitry 280 is independent of the GPU 205, however in alternate implementations, ray tracing circuitry 280 can be internal to the GPU 205 or otherwise form a part of the GPU 205. Such implementations are contemplated. In one implementation, the ray tracing circuitry includes a testing circuitry 282 that is configured to test a ray against primitives, e.g., included within an acceleration structure such as a bounding volume hierarchy (BVH). The testing circuitry 282 further includes a plurality of low-precision (or “reduced-precision”) testing filters 286a-286n and a full-precision testing filter 288. It is noted that although only a single full-precision testing filter 288 is shown for the sake of brevity, in various implementations multiple full-precision filters can be implemented based on application specifics.

In one implementation, ray tracing circuitry 280 is configured to perform ray tracing to render a three dimensions (3D) scene by using the acceleration structure to perform ray tracing operations, including testing for intersection between light rays and objects in a scene geometry. In some implementations, majority of the processes involved in ray tracing are performed by programmable shader programs, executed on the compute units 255A-N. In an implementation, ray tracing circuitry 280 as described herein includes specialized hardware components or dedicated processing units designed to accelerate ray tracing, a rendering technique used in computer graphics to generate highly realistic images by simulating the interaction of light and objects in a scene.

In operation, during a ray intersection test, computations are performed to determine if a ray originating at a given (originating) source intersects with a geometric primitive (e.g., triangles, implicit surfaces, or complex geometric objects). When an intersection is identified, a distance from the origin of the ray to the intersection is calculated. In an implementation, ray tracing tests use a spatial representation of nodes, such as those in the BVH. In the BVH, each non-leaf node may represent an axis-aligned bounding box that bounds the geometry of all children of that node. In one example, a root node represents the maximum volume over which the ray intersection test is performed. Leaf nodes represent triangles or other geometric primitives on which ray intersection tests are performed.

In an implementation, when constructing an acceleration structure, ray tracing circuitry 280 is configured to store data pertaining to primitives in a compressed data format. In one or implementations, acceleration structures can be formed as a combination of top level acceleration structure (TLAS) and bottom-level acceleration structure (BLAS). The TLAS (e.g. internal nodes) includes a hierarchical data structure that organizes a collection of BLAS (e.g., leaf nodes) representing individual geometric objects or primitives within a scene. The TLAS is designed for rapid traversal of rays through the scene by identifying relevant BLAS instances that may intersect with the ray. In an implementation, data corresponding to geometric primitives, e.g., to be utilized for building the acceleration structure can be provided in a pre-compressed format, such that a ray tracing application can compute compressed geometry representation and upload this data to a GPU memory for further processing.

In one implementation, in order to encode primitive data for use in construction of acceleration structures, primitives are clustered and stored in fixed-size data blocks (hereinafter “Dense Geometry Format” or DGF blocks). Each DGF block stores data corresponding to primitives that are spatially localized in a given scene. That is, data in each DGF block corresponds to primitives that can be grouped together to represent a single node of the acceleration structure (e.g., bottom-level acceleration structure or BLAS internal node). Since the primitives are clustered before the resulting acceleration structure is constructed, build speed can be substantially enhanced. In an example, a predetermined number of DGF blocks (e.g., storing data for a total of 65-128 primitives) can together form a data node that represents a single BLAS internal node of a BVH. A data node reference is generated for each data node storing multiple DGF blocks, e.g., at a point when these data nodes are baked. This reference can be mapped to the BLAS node it represents. The BLAS node is constructed based on the data node reference. This node can then be combined with other TLAS and BLAS nodes to complete construction of the BVH.

In one implementation, the DGF block is a fixed-size data block, e.g., consisting of an array of data blocks totaling 128 bytes that encode primitive data. In this example, each DGF block stores a maximum of 64 primitives and 64 vertices. This data structure enables partitioning meshes into small, spatially localized primitive sets, and “packs” each set into a minimal number of DGF blocks. An example DGF block is described with respect to FIG. 4.

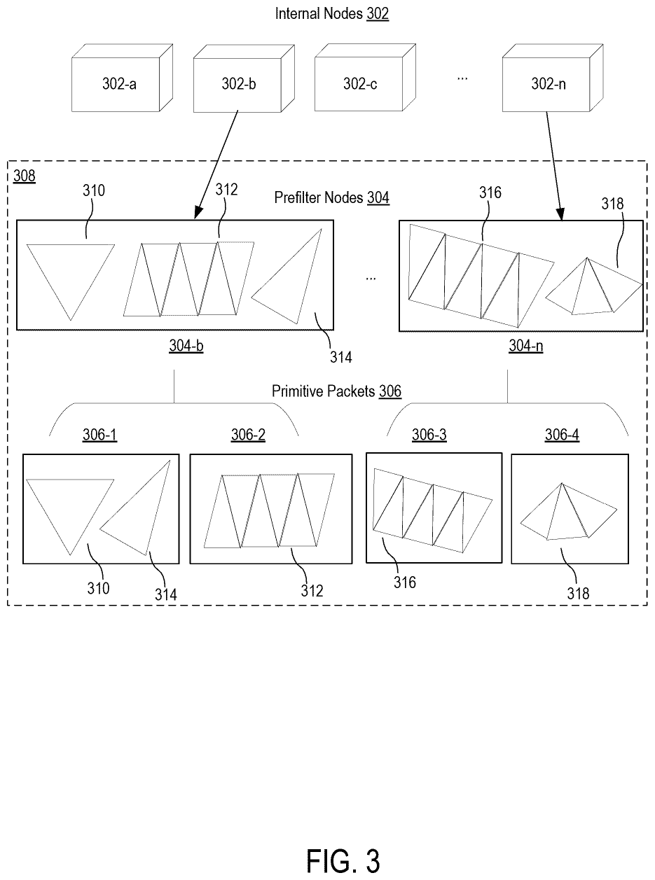

In another implementation, primitive data can be also be compressed using “prefilter nodes”. In an implementation, when a given acceleration structure is built, ray tracing circuitry 280 is configured to pre-quantize a group of primitives and store them compactly (e.g., in a compressed format) within a given node of the structure (e.g., as nodes generated between internal nodes and leaf nodes of a BVH). These nodes are hereinafter referred to as “prefilter nodes.” Exemplary prefilter nodes are described with respect to FIG. 3. The pre-quantized group of primitives can be tested simultaneously against a single ray. In one implementation, with pre-quantization of the primitives, the ray tracing circuitry 280 does not need to perform full-precision testing of a primitive if an intersection test using low-precision testing has indicated that none of the pre-quantized primitives could be hit by a given ray. If low-precision testing is inconclusive for one or more of the primitives, then a full-precision test is performed for only those one or more primitives.

In an implementation, to pre-quantize the group of primitives to generate prefilter nodes, the ray tracing circuitry 280 is configured to compute bounds around the group of primitives and round a minimum corner of the resultant bounding box (e.g., down to “bfloat16” (16 bit floating point) values for compactness. Further, in an implementation, a maximum corner of the bounding box is rounded up such that the bounding box has a power-of-two size in each dimension. The power-of-two box dimensions can provide computational benefits in that the bounding box can be compactly stored, e.g., by only storing the bfloat 16 value of a minimum corner and exponent byte of the power-of-two box dimensions. Further, processing efficiency of the ray tracing circuitry 280 can be improved by quantizing the primitives, since multiplication and division of a floating-point value by a power-of-two can be simply performed by adding or subtracting the floating-point values from the exponent contained within the floating-point value. Likewise, multiplication or division of an integer by a power-of-two can also be done by shifting the bits to the left or right. In one implementation, data associated with the pre-quantized and full-precision primitives is stored in memory 284.

In operation, when intersection tests are performed, the ray tracing circuitry 280 tests a given ray against a set of compressed primitives (stored using DGF nodes or prefilter nodes) simultaneously using the plurality of low-precision testing filters 286 in parallel. The data corresponding to the set of compressed primitives is decoded by node decompression circuitry 281 from encoded primitive data stored in DGF nodes and/or prefilter nodes. Testing the set of primitives simultaneously using the low-precision testing filters 286, the ray tracing circuitry 280 can cull instances where a ray misses a triangle. This eliminates the need to test all instances using a full-precision test. That is, for each set of primitives, a low-precision intersection test can filter the list of primitives prior to full-precision intersection testing. Since hardware requirements for full-precision intersection testing are significant, using multiple low-precision intersection test filters (such as filters 286 in parallel) can reduce the number of full-precision tests needed. In doing so, computational resources (and potentially silicon space) can be saved and the efficiency of the ray tracing circuitry 280 may be enhanced.

In one implementation, simultaneous testing of the primitives is performed using low-precision testing filters 286 in parallel. These tests are used by shader programs running on the compute units 255A-N to generate images using ray tracing. The generated images are then queued for display by command processor 235. In an implementation, with compression of primitive data, the ray tracing circuitry 280 does not need to perform full-precision testing of a triangle if an intersection test using low-precision testing has indicated that none of the quantized primitives could be hit by a given ray. If low-precision testing is inconclusive for one or more of the primitives, only then a full-precision test is performed for those primitives. By reducing the number of full-precision tests that are performed, computational efficiency of the system can be improved.

Turning now to FIG. 3, a block diagram illustrating compression of primitive data using prefilter nodes is described. It is noted that even though the example in FIG. 3 describes compression of triangle data, similar methodologies can be extended to perform data compression and encoding for data corresponding to other primitive types.

In an implementation, using prefilter nodes, a quantization circuitry (not shown) is able to quantize and group triangles as primitive packets in leaf nodes of an acceleration structure. As depicted in the figure, multiple prefilter nodes 304-a to 304-n are generated between internal nodes 302 and leaf nodes 308 of a given acceleration structure (such as a bounding volume hierarchy). In an implementation, the prefilter nodes are generated to filter out triangles (both individual triangles and group of triangles), and create primitive packets 306. In one implementation, primitives from internal nodes 302 are quantized (i.e., to generate low-precision primitives) and stored as prefilter nodes 304. Further, full-precision primitives can be stored as primitive packets 306. Access to the primitive packets 306, for full-precision intersection can be conditional on inconclusive results from low-precision testing of the prefilter nodes 304. In one implementation, the prefilter nodes 304 and the primitive packets 306, cumulatively form the leaf nodes 308 of the BVH, in that a given a branch of the structure can be replaced by the prefilter nodes 304 and primitive packets 306 and together a testing circuitry (e.g., testing circuitry 282) performs primitive intersection testing for the BVH.

In another implementation, the prefilter nodes 304 are generated as a last layer of the internal nodes 302. In such a case, the testing circuitry stops testing after the prefilter nodes 304 are tested if conclusive results for such testing are ascertained. That is, for nodes providing conclusive testing results, the testing circuitry need not continue to test the full-precision triangles stored as primitive packets 306. More specifically, low-precision intersection is performed by the low-precision testers on the prefilter nodes 304, while the full-precision intersection testing is performed by the full-precision intersection testers on the primitive packets 306 (each time low-precision testers generate an inconclusive result).

As shown in the figure, the internal nodes 302 include internal nodes 302-a to 302-n. In one implementation, each internal node 302 corresponds to a bounding volume that encloses its child nodes (either internal nodes or leaf nodes with triangles). For instance, internal node 302-b includes individual triangles 310 and 314 and a set of overlapping triangles 312. Further, internal node 302-n includes overlapping triangle sets 316 and 318. Other internal nodes can similarly include triangles and triangle sets. In an example, a prefilter node 304-b is generated encompassing the individual triangles 310 and 314 and the overlapping triangle 312 corresponding to the internal node 302-b. Similarly, a prefilter node 304-n is generated corresponding to internal node 302-n, that includes overlapping triangles 316 and 318.

In an implementation, the quantization circuitry quantizes individual triangles and overlapping triangles corresponding to a prefilter node 304 and stores them compactly in a BVH node, e.g., as primitive packets in a leaf node. For example, from prefilter node 304-b, primitive packets 306-1 and 306-2 are generated, where packet 306-1 includes individual triangles 310 and 314 and packet 306-2 includes overlapping triangles 312. Further, primitive packets 306-3 and 306-4 are generated corresponding to prefilter node 304-n, such that packet 306-3 includes overlapping triangle set 316 and packet 306-4 includes overlapping triangle set 318. It is noted that objects other than triangles could also be filtered using methods described herein, and such implementations are contemplated.

In one implementation, in order to pre-quantize the group of triangles in a leaf, i.e., to generate a primitive packet 306, the bounds around each group of triangles in the leaf node are computed, and a minimum corner of the resultant bounding box is rounded down to bfloat16 values. Further, the maximum corner of the bounding box is rounded such that the box has a power-of-two size in each dimension (thereby letting the quantization circuitry store the box size as just the power, or exponent, or other suitable compact integer). Once the bounding box is optimized, the node is stored in the BVH along with the position of the box, and quantized triangle vertex coordinates (quantized relative to the bounding box) for all of the triangles grouped together within a given leaf node.

In one implementation, by pre-quantizing the triangles, the testing circuitry does not need to fetch high-precision triangle data at all if testing the quantized triangles can show that none of these triangles could actually be hit by a ray. In another implementation, only a subset of the high-precision triangle data may be fetched, e.g., associated with quantized triangles for which intersection testing generates inconclusive results.

FIG. 4 illustrates a Dense Geometry Format (DGF) block 400 for storing encoded primitive data. Again, even though the example in FIG. 4 describes compression of triangle data, similar methodologies can be extended to perform data compression and encoding for data corresponding to other primitive types.

In one implementation, the DGF block 400 stores encoded data corresponding to triangle vertices as well as triangle mesh data. In an implementation, triangle vertex data is encoded using a signed “fixed-point grid”. As described herein, a fixed-point grid is taken to mean a representation of triangle vertices using fixed-point coordinates rather than floating-point values. The fixed-point grid, in one implementation, can be used due to their lower memory requirements and faster processing speed. A signed fixed-point grid divides a coordinate space (e.g., 2D plane or 3D space) into a grid of fixed-size cells or bins. Each vertex of a triangle is quantized by mapping its floating-point position to a grid cell within the fixed-point coordinate space. The floating-point position is multiplied by a scaling factor (e.g., power of two scaling factor) to convert it into a fixed-point value. For each vertex of a triangle (or other geometric primitive), its position is quantized to a grid cell using the fixed-point representation. The quantized grid cell serves as an approximation of the original floating-point position. In an implementation, data corresponding to quantization of vertices includes a 24 bit signed anchor position in the grid. A variable-width (e.g., 1-16 bits) unsigned offset for each vertex (relative to the anchor position) is also stored. Finally, a power-of-2 scale factor, used to map the quantization grid to floating-point coordinates for each triangle vertex, is stored as an “IEEE biased exponent.”

In one implementation, encoded vertex data and other triangle data is stored as part of triangle mesh(es) data. The triangle mesh data includes a set of vertices, where each vertex is defined by its position (e.g., in a three-dimensional space) and additional attributes like normals, texture coordinates, or colors. The mesh is composed of triangles, where each triangle is defined by indices pointing to the vertex data. For example, triangle meshes are often stored using optimized data structures like bounding volume hierarchies (BVHs) or k-dimensional trees (KD-trees). These structures organize the triangles spatially to accelerate ray-triangle intersection tests.

In one implementation, mesh connectivity data is encoded using triangle strips, and an index buffer. Triangle strips are used to describe and render a continuous surface or object composed of triangles. In a triangle strip, each triangle shares an edge with the previous primitive in the sequence. This shared edge is formed by two consecutive vertices in the vertex list. In one implementation, by sharing vertices between adjacent triangles, primitive strips require fewer vertex data compared to individual triangle data, which reduces memory consumption and improves rendering performance.

In one or more implementations, the index buffer includes a fixed number of control values for triangles in the triangle strip. Each control value is indicative of the triangle's position relative to previously identified triangles in the strip. In an implementation, the length (or size) of the index buffer is determined based on the contents of the control values, as described later. The index buffer includes a set of bits, wherein each bit corresponds to an index of a given vertex of a triangle. The index buffer is organized into two parts. The first parts includes an array of bits, storing one bit per vertex indicative of whether a first index to a given vertex is encountered (hereinafter “first index”). The second part includes ‘N’ bits per index to store each non-first index to a vertex (hereinafter “non-first index”), wherein the value of N is predefined, and the value of N is stored at the data block header. In an implementation, the index buffer is compressed by re-ordering the vertices by first use and omitting storage of the first index corresponding to every vertex (this index can be computed by incrementing a counter).

In one implementation, a primitive identifier can be derived from the triangle's position in the strip, and therefore does not need to be stored explicitly in the data block, further reducing memory usage. In another implementation, the data blocks further include encoded geometry identifiers (GeomID). These can be encoded in two modes referred to as a “constant mode” and a “palette mode.” In constant mode encoding, a geometry ID field in the data block stores a geometry ID and an opaque flag (indicating whether a triangle is opaque or transparent to incoming rays of light) that apply to all triangles. In palette mode, the geometry ID field is interpreted based on least significant bits (LSB) and most significant bits (MSB). These and other implementations are explained in further detail with respect to the description that follows.

As shown in the figure, DGF block 400 is a fixed-size data block, e.g., consisting of multiple buffers storing encoded triangle data and totaling 128 bytes. In this example, the DGF block 400 stores a maximum of 64 triangles and 64 vertices. This data structure enables partitioning triangle meshes into small, spatially localized triangle sets, and “packs” each set into a minimal number of DGF blocks.

In one implementation, the first 5 Double Words (“Dwords”) of the DGF block 400 include a fixed header 402, whose structure is as shown in the figure (all bit fields are ordered from least significant bit (LSB) to most significant bit (MSB)). “Dwords” typically refer to “double words” in the context of computer memory that are units of data twice the size of a standard word. The specific size of a double word can vary depending on the computer architecture and the word size of the system. For implementations described herein, a word is 16 bits (2 bytes), and Dwords would be 32 bits (4 bytes). The layout of the header 402 is given by the following pseudocode.

| | | |
|---|---|---|
| struct DGFHeader | | |
| { | | |
| // DWORD 0 | | |
| uint32_t magic | : | 8; // must be 0x6 |
| uint32_t bits_per_index | : | 2; // Encodes 3,4,5,6 |
| uint32_t num_vertices | : | 6; // Number of vertices (1-64) |
| uint32_t num_triangles | : | 6; // Number of triangles (1-64) |
| uint32_t geom_id_meta | : | 10; |
| // DWORD 1 | | |
| uint32_t exponent | : | 8; // Float32 scale (exponent-only) |
| with bias 127. Values | | |
| int32_t x_anchor | : | 24; |
| // DWORD 2 | | |
| uint32_t x_bits | : | 4; // 1-16 (add 1 when decoding) |
| uint32_t y_bits | : | 4; // 1-16 (add 1 when decoding) |
| int32_t y_anchor | : | 24; |
| // DWORD 3 | | |
| uint32_t z_bits | : | 4; // 1-16 (add 1 when decoding) |
| uint32_t geom_id_mode | : | 1; // 0 = Constant |
| Mode | | |
| int32_t z_anchor | : | 24; |
| // DWORD 4 | | |
| uint32_t prim_id_base | : | 29; |
| uint32_t unused | : | 3; // must be 0 |

// 108B of variable-length data segments follow.

}

As shown in the figure, vertex data 404 is packed in the DGF block 400, immediately following the header 402, in an ascending vertex order 420. In one implementation, the size of each vertex is 4 byte aligned. Further, the size of the vertex data section is also byte-aligned. Pad bits can be inserted as required, and all pad bits must be zero. The pad bits are used to align the data to byte boundaries, which reduces hardware decoding cost. Further, as described herein, a “byte-aligned” buffer refers to a region of memory where data is stored such that each data element or structure begins at an address that is a multiple of a certain byte boundary. This alignment ensures that data can be efficiently accessed by a processor, particularly on architectures that require specific alignment for optimal performance.

The block 400 further includes an optional opacity micro map (OMM) palette 406 that starts on the next byte boundary, and an optional Geometry Identifier (GeomID) palette 408 that starts on a byte boundary following the vertex data 404 and OMM palette 406. The region containing the header 402, vertex data 404, GeomID palette 408, and OMM palette 406 is referred to as the “front buffer” 422. The front buffer 422 is byte aligned, and its total size may be lesser than equal to 96 bytes, in one implementation.

As described earlier, vertices are defined on a signed 24-bit quantization grid. Vertex data 404 stores the following: a 24 bit per coordinate signed anchor position, a variable-width (1-16 bits) unsigned offset for each vertex (relative to the anchor position), a power-of-2 scale factor which is used to map from the quantization grid to floating-point world coordinates (stored as an IEEE biased exponent). The decoded floating-point vertex position can be computed using the following pseudocode.

float3 dgf_decode (int24_t Anchor[3], uint16_t
Offset[3], uint8_t Exponent)
{
int x = Anchor[0] + Offset[0]; // 24b + 16b add.. 25b result
int y = Anchor[1] + Offset[1];
int z = Anchor[2] + Offset[2];
float fx = (float)(x); // convert results to float
float fy = (float)(y);
float fz = (float)(z);
// apply a pow2 scale factor
float scale = ldexp(1.0f, Exponent − 127);
return float3(fx, fy, fz) * scale;
}

With this encoding scheme the maximum representable value is: (0×7fffff+0xffff)*2\hat{ }127=8,454,142*2\hat{ }127 (roughly 1.438e+45), and the minimum representable value is: (0×800000*2\hat{ }127)=−8,388,608*2\hat{ }127 (roughly −1.427e+45). This is a larger theoretical dynamic range than IEEE floating point. The minimum and maximum IEEE floats which can be encoded using the DGF block 400 occurs for exponent 232 and integer positions 0×800001 and 0×7fffff (Decimal values −8388607 and 8388607). These values are: −340282326356119256160033759537265639424.000000 and +340282326356119256160033759537265639424.0.

In an implementation, the DGF block 400 can support exponent values from 1 through 232. In one implementation, if a DGF block encodes an exponent value outside the supported range, all ray-triangle intersection tests against this block may have undefined results. However, ray tracing applications can ensure error-free results across blocks by selecting matching quantization factors for any two neighboring blocks. This can be done by selecting a uniform quantization factor for an entire mesh. In another implementation, combination of base position and vertex offsets during encoding can cause errors for meshes containing very large triangles. This issue can be navigated by choosing a coarser quantization factor (trading off precision), subdividing large, problematic triangles (whether automatically or manually), or reverting to uncompressed geometry for problematic assets.

As described in the foregoing, mesh topology is encoded using triangle strips. In one implementation, the order of the stored vertices is used to minimize the size of the topology encoding. That is, instead of storing data each time a new vertex is referenced for the first time, the first reference is identified by means of a counter. For encoding the mesh topology, the following data structures are generated-triangle control bits 324 and an index buffer 426. The triangle control bits 424 include two control bits per triangle indicating a triangle's position relative to previous two triangles. Further, the length of the index buffer 426 is determined by the contents of the control bits. The index buffer 426 is further organized into two sections-a first-index buffer 412, for storing bits each representing a first reference to a given vertex in a given strip, and non-first indices buffer 410, each representing a non-first reference to a given vertex.

In one implementation, the index buffer is compressed by re-ordering vertices by first use and omitting storage of the first index to every vertex, as identified using the is-first bits. This enables calculating the first index of a given vertex, by simply using a counter, e.g., by counting the number of is-first bits that were encountered before the given vertex. In an example, a single is-first bit per index is used to indicate whether it is the first index to its corresponding vertex. In one example, the first three indices of each vertex are always ‘first references’, and therefore corresponding is-first bits for these indices need not be stored. As shown, data in the first-index buffer 412 is stored in an ascending index order 428. In an implementation, there is one index for each zero bit in the is-first bit vector. The number of indices in the buffer is the number of zero bits in the ‘is-first’ bit vector. Indices whose ‘is-first’ bits are 1 can be calculated by counting bits, instead of storing them explicitly.

In an implementation, the control bits and is-first indices are allocated from the back of the block, and this makes hardware decoding easier because the data are indexed from a known start position, and computations needed to locate data for a particular triangle are reduced. Further, ascending order for the first-index buffer is performed to make the buffer consistent with vertex data (thereby avoiding storing the number of indices).

Further, for the non-first indices buffer 410, the number of bits per non-first index is stored in the header 402. In one example, valid values of the number of bits per non-first index can be 0,1,2,3, encoding 3,4,5, and 6 bits, respectively. In one implementation, the total size of the first-index buffer 412 is lesser than or equal to 24 bytes. Further, the non-first indices buffer 410 is located immediately adjacent to the front buffer 422, as shown. The data in the non-first indices buffer 410 is stored in ascending vertex order 432. The triangle control bits 424 are located at the end of the DGF block 400, and the first-index buffer 412 is stored immediately in front of the triangle control bits 424.

In one implementation, the DGF block 400 further stores geometry identifiers (GeomID 408) and opacity micro-maps flags (OMM flags 406). GeomID 408 can be used to uniquely identify and reference specific geometric entities or elements within a scene. This identifier helps in efficiently managing and manipulating geometric data in various graphics applications. Further, OMM flags cab include Boolean or numerical values associated with materials or objects to control their opacity properties. The GeomID 408 and OMM flags 406 can be stored in two different modes, wherein the mode is selected based on a geometry ID field in the header 402. The two different modes include a constant mode and a palette mode. When the value of the field is 0, a constant mode is selected, and when the value of the field is 1, a palette mode can be chosen.

In constant mode, bit 0 of the geometry ID field 408 includes an opaque flag, and bits 1-9 store a geometry identifier. These values are used for all triangles. In this mode, no additional data is stored in the block 400, and more space is available for vertex data. In palette mode, the geometry ID field is interpreted as LSBs and MSBs. For example, LSBs (4:0) encode a GeomID prefix size in bits (5b, 0-25) and MSBs (9:5) encode a GeomID count (5b, 1-32) (1 bit is added when decoding). For instance, in palette mode, geometry ID field 408 is used to store the properties of the palette. For example, the upper bits encode the number of geometry identifiers in the palette. The lower bits hold the number of bits (out of 25) which have the same value across all IDs (those bits are stored once instead of being repeated). In palette mode, a GeomID palette structure is inserted in the block (as shown by GeomID 408). The position and size of the palette structure are aligned to byte boundaries. In one implementation, pad bits can be appended as required, however all pad bits must be zero.

In one implementation, the GeomID 408 palette consists of a prefix value whose bit length is given in the 5 LSBs of the geometry ID field 408 and a per-triangle index buffer identifying a payload to use for each triangle. The size of each index is given by ceil (log 2 (GeomID count)), wherein ceil is a ceiling function that returns a smallest integer that is greater than or equal to the parameter. Further, an array of N-bit payloads is also provided, where N is 25-prefixSize. In an implementation, the size of the per-triangle index field is only as large as needed to index all stored values. Further, ceil (log 2 (GeomID count)) gives the number of bits needed (using the ID count, which comes from the geometry ID field 408). The LSB of each payload contains an opaque flag. The 25b GeomID and opaque flag for a given triangle are decoded by selecting a payload from the payload buffer, and concatenating it with the prefix value. The following pseudocode illustrates this process:

// Helper function to extract a bit field from the DGF block
uint ReadBits(uint bitPos, uint numBits);
uint get_id_and_opacity(uint geom_id_meta,
uint triIndex, uint triCount);
{
uint prefixSize = geom_id_meta & 0x1f;
uint payloadSize = 25 − prefixSize;
uint geomIDCount = ((geom_id_meta >> 5) & 0x1f) + 1;
uint indexSize = 32 − lzcount(geomIDCount − 1);
uint paletteBitPos = ComputePaletteBitPosition( );
uint prefix = ReadBits(paletteBitPos, prefixSize);
uint indexBufferPos = paletteBitPos + prefixSize;
uint index = ReadBits(indexBufferPos + triIndex *
indexSize, indexSize);
uint payloadBufferPos = indexBufferPos + triCount * indexSize;
uint payload = ReadBits(payloadBufferPos, index, payloadSize);
return (prefix << payloadSize) | payload;
}

In one non-limiting example, supposing a total of 8 triangles, the per-triangle GeomID is given by: 1, 4, 1, 1, 4, 3, 1, and 4. There are 3 unique ID values (1, 4, and 3), so the number of palette entries is computed as 3. In binary these values (as 25b numbers) are given by: 0000000000000000000000001, 0000000000000000000000100, and 0000000000000000000000011 respectively. The upper 22 bits are the same (all zero in this case), so the prefix size is 22. In palette mode, geometry ID field 408 is a 10-bit field split into two halves. The top 5 bits contain the number of entries, e.g., using bias-1 encoding (encodings 0 . . . 31 correspond to 1 . . . 32). For 3 palette entries, the encoded value is computed as 2. The lower 5 bits contain the prefix size (22). Therefore, the value stored in geometry ID field 408 would be: (2<<5)+22=86. The palette has 47 bits of data (25 bits for ID values and 22 bits for prefix size). An extra zero bit is added at the end to align it to a byte boundary (totaling to 48 bits). The resulting bits are given by: 0000000000000000000000 001 100 011 00 01 00 00 01 10 00 01 0.

In an implementation, the prefix bits are stored first. In this case, the prefix bits include 22 zero bits. Next, unshared lower bits for each of the IDs are stored. In this case, 3 IDs with 3 bits each, which are: 001 (decimal: 1), 100 (decimal: 4), and 011 (decimal: 3). Lastly, a per-triangle index which selects an ID for each triangle is stored. The number of bits per index depends on the number of IDs. In this case, there are 3 ids to choose from, which means 2 bits per triangle, and 8 triangles, so 16 bits in total. The per-triangle indices represented in decimal are: 0,1,0,0,1,2,0,1. In binary these values can be represented by 00 01 00 00 01 10 00 01.

In one implementation the OMM palette 406, if present, is also byte aligned. Pad bits are inserted as required, and all such bits must be zero. The OMM palette 408 includes a “hot-patched” section, and a “pre-computed” section (not shown). The hot-patched section is patched at runtime with OMM information when an acceleration structure is constructed. The pre-computed section is computed by encoding circuitry at the time of encoding data within the DGF 400. The size and position of the hot-patched section can be exposed to one or more applications through an API. However, the precise contents of the hot patched section are not exposed. When encoding a DGF block, that is expected to be used with OMMs, the encoding circuitry reserves space for the hot-patched section, and stores the pre-computed section immediately after it. In one example, the hot-patched section contains 8 bytes, and an additional 4 bytes for each OMM descriptor. The application using the block initializes this space with zeros. The pre-computed section includes a per-triangle index indicating which OMM descriptor to use. Triangles are ordered from front to back in ascending order 430. The number of bits per index is derived from an OMM descriptor count field in the header 402. The pre-computed section is padded out to the next byte boundary, and all pad bits must be zero. In one or more implementations, unused space in the DGF block 400, e.g., resulting from OMM Palette 406 or GeomID palette 408 data not being stored and/or otherwise, can be utilized to stored additional vertices data.

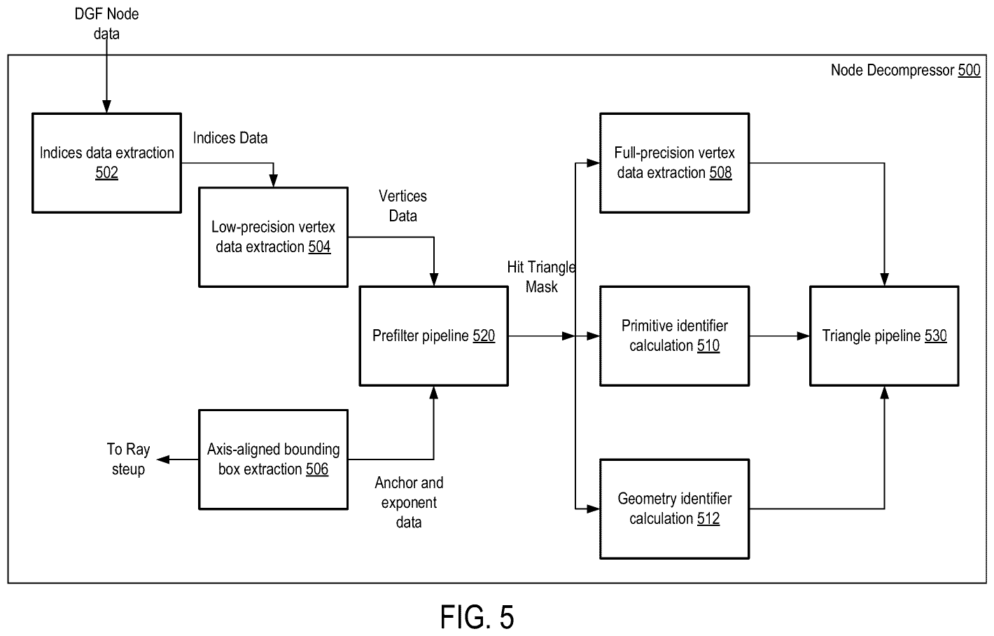

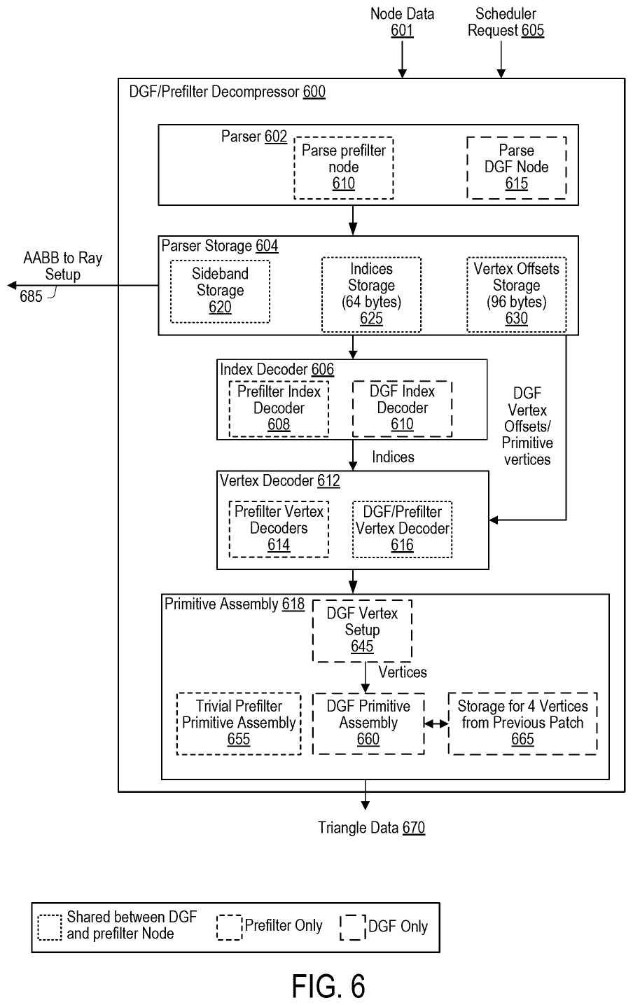

FIG. 5 is a block diagram illustrating ray testing using compressed primitive data. In the example shown in FIG. 5, ray intersection tests are described with respect to testing a ray against triangles. However, in various implementations other primitives can be similarly tested. In an implementation, the compressed triangle data is stored using DGF nodes (as described with respect to FIG. 4), prefilter nodes (as described with respect to FIG. 3), or a combination of prefilter nodes and DGF nodes. The example shown in FIG. 5 only describes intersection testing triangles based on data decoded from DGF nodes. Intersection testing using a combination of DGF nodes and prefilter nodes is described in FIG. 6.

This compressed triangle data is fed to an array of low-precision intersection testers (e.g., testers 286a-n described in FIG. 2), and triangles that are not rejected by the low-precision intersection testers (e.g., generating an inconclusive intersection result) are forwarded to the full-precision intersection testers for final intersection testing. Using low-precision intersection testers to filter out triangles before the final intersection testing reduces the area required for bulk ray-triangle intersection, since low-precision intersection testers are cost-effective and filter data before engaging the more expensive full-precision testers.

In operation, an intersection scheduler (not shown) requests node decompressor 500 to decode encoded triangle data (DGF node data) stored in DGF nodes for an intersection pipeline (e.g., a prefilter pipeline 520) for intersection testing. The prefilter pipeline, as used herein, is a processing pipeline that is formed using processes and/or circuitries that involve decoding encoded triangle data stored in a DGF node and/or prefilter nodes, and simultaneously performing low-precision intersection tests for a single ray against each triangle of a given set of triangles represented by the decoded data. In one implementation, the intersection scheduler forwards the entirety of the decoded data to the prefilter pipeline 520 in successive clock cycles (e.g., one set of triangles per clock cycle of the prefilter pipeline 520). Further, for each triangle which survives the intersection testing performed using prefilter pipeline 520, high-precision triangle data is decoded from the encoded node data and forwarded to the high-precision or triangle pipeline 530 for further testing. In an implementation, the DGF block is retained in a buffer for the duration of this process.

As shown in the figure, a DGF block is firstly processed for decoding indices data from encoded DGF node data (block 502). In an example, a DGF block is processed by one or more index decoders to extract the indices data. As described with respect to FIG. 4, encoded triangle data in DGF blocks is stored as triangle meshes. The triangle mesh data includes a set of vertices, where each vertex is defined by its 3D position and additional attributes like normals, texture coordinates, or colors (as described above). Further, each triangle is defined by indices pointing to corresponding vertex data. In one implementation, triangle mesh data is encoded using a triangle strip, and an index buffer. In a triangle strip, each triangle shares an edge with the previous triangle in the sequence. This shared edge is formed by two consecutive vertices in the vertex list. In one implementation, by sharing vertices between adjacent triangles, triangle strips require fewer vertex data compared to individual triangles, which reduces memory consumption and improves rendering performance.

In one or more implementations, the index buffer includes a fixed number of control bits per-triangle in the triangle strip (e.g., 2 bits), wherein each control bit indicates the triangle's position relative to previously identified triangles in the strip. In one implementation, the control values include ‘RESTART’ bits, ‘EDGE1’ bits, ‘EDGE 2’ bits, and ‘BACKTRACK’ bits. In one implementation, the value of the RESTART bits is 0 (bits ‘00’), and these bits are used to start a new strip, specifying 3 vertex indices for a triangle. Further, the EDGE1 bits (value 1, bits ‘01’) represent reusage of a second edge of a last identified triangle as a first edge of a current triangle. Similarly, the EDGE2 (value 2, bits ‘10’) bits represent reusage of a third edge of a last identified triangle as a first edge of a current triangle.

In one implementation, the BACKTRACK bits (value 3, bits ‘11’) represent that an opposite edge of a last identified triangle's predecessor triangle is reused. In this implementation ‘opposite edge’ is given by EDGE1 bits if the last triangle used EDGE2, or EDGE2 bits if the last triangle used EDGE1. Further, backtracking is not used to form a current triangle, unless the last triangle is formed using EDGE1 or EDGE2. That is, backtracking is not used to form a current triangle, after a new strip is initiated or if the last triangle was formed using backtracking. It is noted that when an edge of a previously identified triangle is reused, the reused edge is always the first edge in the new triangle, and the other two edges connect to a new vertex, which is always the third vertex in the triangle.

As described earlier, the length (or size) of the index buffer is determined based on the content of the control bits. For example, the index buffer has 1 bit for each triangle, and additional two bits for each triangle whose control bits are 0. The control bits for the first triangle in a new strip are always 0, and therefore the first 3 bits are always 1, and are not stored. The index buffer includes two sections each storing a set of bits, wherein each bit corresponds to a triangle vertex. The first section of the index buffer includes a data array of “is-first” bits. Each “is-first” bit indicates whether it is the first index corresponding to a given vertex. The second section includes a second array of bits, storing ‘N’ bits per index to store each non-first index, wherein the value of N is predefined, and the value of N is stored at the data block header. In one implementation, the index buffer is compressed by re-ordering vertices by first use and omitting storage of the first index to every vertex, as identified using the is-first bits. This enables calculating the first index of a given vertex, by simply using a counter, e.g., by counting the number of is-first bits that were encountered before the given vertex. In an example, a single is-first bit per index is used to indicate whether it is the first index to its corresponding vertex. Further, the non-first indices are directly stored in a tightly packed buffer (i.e., a data structure where elements are stored contiguously without any additional padding or alignment between them).

In one implementation, the DGF block processed for decoding indices data using the following exemplary process:

```
r ← 1
indexAddress ← [0, 1, 2]
for k = 1 → index do
  ctrl ← Control [k]
  prev ← indexAddress
  if ctrl = RESTART then
    r ← r + 1
    indexAddress ← [2r + i − 2, 2r + i − 1, 2r + i]
  else if ctrl = EDGE1 then
    indexAddress ← [prev[2], prev[1], 2r + k]
    bt ← prev[0]
  else if ctrl = EDGE2 then
    indexAddress ← [prev[0], prev[2], 2r + k]
    bt ← prev[1]
  else if ctrl = BACKTRACK then
    if prevCtrl = EDGE1 then
      indexAddress ← [bt, prev[0], 2r + k]
    else
      indexAddress ← [prev[1], bt, 2r + k]
    end if
  end if
  prevCtrl ← ctrl
end for
for k = 0 → 2 do
  vid ← CountFirst (FirstIndex, indexAddress[k])
  if FirstIndex[index Address[k]] = 0 then
    vid ← ReuseBuffer[indexAddress[k] − vid]
  end if
  Vertex [k] ← (Anchor + Offset[vid]) * Scale
end for.
```

In one implementation, the DGF data is further decoded (e.g., by a ray tracing engine) to extract an axis-aligned bounding box (AABB) from the DGF block data (block 506). The AABB is used to set up ray-triangle intersection tests to efficiently test whether a ray intersects a given triangle. As described earlier, to compress triangle data to be stored in DGF blocks, triangle vertices are defined on a signed 24-bit quantization grid. Encoded vertex data in the DGF block includes the following: a 24 bit per coordinate signed anchor position, a variable-width (1-16 bits) unsigned offset for each vertex (relative to the anchor position), a power-of-2 scale factor which is used to map from the quantization grid to floating-point world coordinates (stored as an IEEE biased exponent). In an implementation, the AABB is extracted as a function of the anchor position (‘A’), the exponent (‘x’), and the bit-width (‘w’) of the unsigned offset. The lower bound of the AABB is given by the following example sequence:

$$Min = int\_to \_float ( A ) * 2 \hat{} x$$

Further, a power-of-2 extent for the box is computed as:

$$Extent = 2 \hat{} ( x + w ) .$$

In an implementation, the anchor and exponent values are fed to the prefilter pipeline 520, along with other triangle data. For example, using the indices data decoded from the DGF node data, low-precision vertex data corresponding to the AABB is extracted (block 504). Low-precision vertex data can be generated, in one implementation, by shifting each stored vertex left or right to align it to a bit width (“Q”) of the prefilter pipeline 520. As described herein, a bit width of an intersection pipeline, such as prefilter pipeline 520, defines a number of bits that are used to perform low-precision intersection testing. The bit-width can be a constant for different implementations chosen based on tradeoff between precision and silicon area. Further, as used herein, “shifting” means moving binary number left or right by a certain number of positions. Shifting can be used for tasks like multiplication or division by powers of two, bit manipulation, and optimizing performance. A left shift (<<) operation shifts all the bits in a binary number to the left by a specified number of positions. For each shift left, the binary number effectively gets multiplied by 2. A right Shift (>>) operation shifts all the bits in a binary number to the right by a specified number of positions. For each shift right, the binary number effectively gets divided by 2 (with rounding towards negative infinity).

In one implementation, if the stored offsets are lesser than 10 bits, a left shift is performed, otherwise, a right shift is performed. The shifted offset (O) is computed from a vertex offset (v) using the following exemplary sequence:

$$O = v ≪ ( Q - w ) .$$

In case the (Q-w) subexpression is negative, a right shift is performed to generate the low-precision vertex data. Generation of the low-precision vertex data is shown using the following pseudocode:

```
void vertex_extraction( ushort3 verts[ ] ) // generates 10b vertex offsets
{
  int shift_x = 10 − header.XBits; // 4b adds with constants
  int shift_y = 10 − header.YBits; // computed once for all vertices
  int shift_z = 10 − header.ZBits;
  for( each vertex )
  {
    // extract x,y,z from the bit-packed vertex array (muxing)
    ushort3 v = ExtractVertexOffset(i);
  // shift to 10 bits, inserting with zeros
  // negative shift values must do a right shift.
  v.x = v.x << shift_x;
  v.y = v.y << shift_y;
  v.z = v.z << shift_z;
  verts[i] = v;
  }
}
```

Based on the low-precision vertices data, a set of triangles (e.g., included within the extracted AABB) is issued to the prefilter pipeline 520 for testing against a ray using low-precision intersection testers. The low-precision testers test all triangles in the set against the setup ray. In an implementation, the decompressor 500 feeds decoded triangle data to low-precision testers in parallel, e.g., one set of triangles per clock cycle of a given low-precision tester. Further, triangle data from each set of triangles is fed to each low-precision tester, e.g., at a rate of N triangles per clock (batch test), wherein N is determined based on the width of the low-precision testers (i.e., number of bits that each tester can process simultaneously), and the number of low-precision tests that can be issued per clock. Further, the number of triangles in a given set of triangles is determined based on a total number of low-precision intersection testers, number of vertex decoders (shown in FIG. 6), and a control bit associated with each triangle (which determines the number of vertices which need to be consumed). In an implementation, since triangles connectivity is encoded using triangle strips, where triangles in each strip share vertices with other triangles, a predetermined number of vertices from each set are retained for possible re-use when testing triangles in the next set. Using the triangle strip to drive the intersection scheduling allows for full throughput with a smaller number of vertex decoders.

In an implementation, a “hit triangle mask” corresponding to triangles which are not rejected by the low-precision intersection testers, i.e., having an inconclusive intersection result, is used to drive the triangle pipeline 530. The triangle pipeline, as used herein, includes processes and/or circuitries that involve decoding encoded triangle data stored in a DGF node and/or prefilter nodes, and performing high-precision intersection tests for a single ray against each triangle of a given set of triangles represented by the decoded data. Further, a hit triangle mask is a data structure, e.g., including a bit array associated with each candidate triangle. Each bit in the array corresponds to a triangle, indicating whether that triangle intersects with the ray or not. This mask can be efficiently updated during the intersection tests to mark which triangles are hit by the ray.

In response to processing the hit triangle mask, the decompressor 500 further decode encoded triangle data from the DGF node to generate high-precision vertex data (block 508). In one implementation, high-precision vertex data (V) for a triangle is generated by computing a sum of the per-vertex offset (v) to the anchor (A), converting the sum to a floating point value, and applying the power-of-2 scale to the converted sum to generate a scaled sum. The scaled sum is then representative of the high-precision vertex data. This is shown using the following exemplary sequence:

$$V = int\_to \_float ( A + v ) * 2 \hat{} x .$$

Generation of high-precision vertex data is depicted using the following pseudocode:

```
// Cost per vertex is:
// − 3x integer add (24b+16b)
// − 3x int25 to float (third is shared with aabb_extract)
// − 3x 8b add (exponent adjustment, third is shared with aabb_extracdt)
float3 get_highp_vertex( uint index )
{
    // extract x,y,z from the bit-packed vertex array (muxing)
  // can share gates with lowp vertex extraction
  ushort3 offset = ExtractVertexOffset(index);
  // apply offset to anchor ( int24 + uint16 ) x 3 verts
  uint3 vi = uint3(header.AnchorX, header.AnchorY, header.AnchorZ);
  vi = vi + offset;
  // convert result to float, then adjust exponent
  // one of three verts could share gates with aabb_extract
  return int25_to_float3(vi) * pow(2,header.Exponent−127);
}
```

The high-precision vertex data is forwarded to the triangle pipeline for along with primitive identifiers and geometry identifiers associated with each triangle. This is as shown in blocks 510 and 512. In an implementation, the primitive identifiers of each triangle is given by adding a 29 bit per-block base to the triangle's position in the strip. Further, the geometry identifier is extracted based on respective encoding modes, i.e., constant mode or palette mode, as described with respect to FIG. 4. The decoded high-precision vertex data, along with the primitive and geometry identifiers are forwarded to the triangle pipeline 530 for final intersection testing using full-precision intersection testers. In one implementation, full-precision tests can be conducted for triangles for which low-precision intersection test generates an inconclusive result. In one implementation, encoded triangle data stored in DGF nodes allows generation of both low-precision and high-precision vertex data from the same encoded data, therefore eliminating data duplication.

In the implementations described herein, parallel rejection testing of large groups of triangles enables a ray tracing circuitry to perform many ray-triangle intersections without fetching additional node data (since the data can be simply decoded from the DGF node, without the need of duplicating data at multiple memory locations). This improves the compute-to-bandwidth ratio of ray traversal and provides a corresponding speedup. These methods further reduce the area required for bulk ray-triangle intersection by using cheap low-precision pipelines to filter data ahead of the more expensive full-precision pipeline.

In one or more implementations, decompressor 500 in the prefilter pipeline 520 is configured to support decoding of data from both prefilter nodes as well as DGF nodes (as described in FIG. 6). In an implementation, the intersection scheduler pipelines data decoding requests to the decompressor 500 for multiple rays coalesced against the same node. All the rays coalesced against the same node are sent first before switching to another node. The decompressor 500 switches to the next ray only after decoding the last batch test for the current ray. Further, the decompressor 500 switches to the next node only after decoding the last batch test of the last ray for current node it is processing.

Turning now to FIG. 6, a node decompressor 600, for decoding encoded triangle data stored within DGF nodes and/or prefilter nodes, is described. In the example shown in FIG. 6, dashed and dotted lines depict processes or components individually reserved for either DGF nodes or prefilter nodes or shared between the prefilter nodes and DGF nodes (according to the provided legend at the bottom of the figure).

As described in the foregoing, decompressor 600 is configured to support decoding of data from both prefilter nodes as well as DGF nodes. In an implementation, the intersection scheduler pipelines data decoding requests (e.g., scheduler request 605) to the decompressor 600 for multiple rays coalesced against the same node. The decompressor 600, responsive to a scheduler request, accesses node data 601, from a prefilter node and/or a DGF node. A parser 602 individually parses prefilter node data (process block 610) and DGF node data (process block 615). The parser parses each different node to extract indices data 625, vertex data 630, and sideband data 620 (e.g., application-defined data depending on the triangle order, such as per-triangle colors, normals, or index buffers.). In one example, the indices data 625 includes data up to 64 bytes and the vertex data 630 includes data up to 96 bytes. These data limits can be configured when encoding data using the DGF blocks and/or prefilter nodes. Further, this data can be stored in a local memory buffer allocated to the decompressor (e.g., parser storage 604).

In an implementation, the stored data in the parser storage 604 is used to extract an axis-aligned bounding box (AABB) for ray setup which is to be tested against multiple triangles. According to the implementation, the AABB is used to set up ray-triangle intersection tests to test whether the ray intersects a set of triangles. As described earlier, to compress triangle data to be stored in DGF blocks, triangle vertices are defined on a signed 24-bit quantization grid. Encoded vertex data in the DGF block includes the following: a 24 bit per coordinate signed anchor position, a variable-width (1-16 bits) unsigned offset for each vertex (relative to the anchor position), a power-of-2 scale factor which is used to map from the quantization grid to floating-point world coordinates (stored as an IEEE biased exponent). In an example, the AABB is extracted as a function of the anchor position, the exponent, and the bit-width of the unsigned offset.

In one implementation, vertex offset data decoded using the vertex data 630 (from the parsed DGF node 615), along with prefilter vertices decoded using the parsed prefilter node 610 is accessed by vertex decoder 612. Further, the indices data 625 is accessed by an index decoder 606. The index decoder 606 includes a prefilter index decoder 608 and a DGF index decoder 610. The prefilter index decoder 608 decodes a first predetermined number of indices per clock cycle and feeds the indices into the same number of prefilter vertex decoders 614. The DGF index decoder 610 also decodes a second predetermined number of indices per clock cycle. In one example, less than 3 indices may be required per triangle to supply to the vertex decoder 612 from the DGF index decoder 610. The DGF index decoder 610 must be aware of triangle boundaries and does not send partial triangles to the vertex decoder 612. Further, in addition to the decoded indices, the DGF index decoder 610 also sends primitive IDs, is-first bits and control bits for each triangle with each batch. This data can be stored in a buffer to be used later for primitive assembly, e.g., in a first-in-first-out manner. In an implementation, the DGF index decoder 610 decodes the control bits of the next 2 triangles, following the current set of triangles, so that vertices of the current set can be reused in the primitive assembly of the next set.

In an implementation, the prefilter vertex decoders 614 decode quantized triangle vertices using the prefilter vertices data accessed from the parser storage 604, and indices extracted by the prefilter index decoder 608. In one example, quantized triangle vertices includes 3 vertices for each triangle. In another implementation, DGF/Prefilter vertex decoder 616 is configured to decode data to extract vertices from both the DGF nodes as well as prefilter nodes. For example, the DGF/prefilter vertex decoder 616 decodes quantized triangle vertices based on prefilter vertices data accessed from the parser storage 604, and indices decoded by the prefilter index decoder 608. Further, the DGF/prefilter vertex decoder 616 can also decode DGF vertex offsets based on vertex offset data accessed from the parser storage 604, and indices decoded by the DGF index decoder 610.

The decoded vertices data from both the prefilter nodes as well as the DGF nodes are fed to a primitive assembly process 618. Within the primitive assembly process 618, a DGF vertex setup 645 is performed, wherein low-precision vertices are generated from the decoded vertex offsets (as disclosed in FIG. 5). These vertices are forwarded to a DGF primitive assembly 660 where the triangles corresponding to the vertices are assembled into a set of triangles for traversal and intersection testing with the setup ray. In one implementation, each time intersection test for a set of triangle is concluded, a predefined number of vertices are retained from the set to be reused in the primitive assembly of the next set. In the example shown in the figure, 4 vertices are stored from the previous batch (block 665) that are reused by the DGF primitive assembly 660 for the current set of triangles tested against the ray. This is done since triangles are interconnected using triangle strips and vertices are shared between triangles.

Further, vertices data corresponding to the prefilter nodes is used by a prefilter primitive assembly 655. In an implementation, within the primitive assembly 655, low-precision triangles from prefilter nodes are grouped, e.g., stored as leaf nodes of an acceleration structure. Further, the high-precision primitives can be stored as primitive packets (as disclosed in FIG. 3). Access to the primitive packets, for full-precision intersection, is conditional on inconclusive results from low-precision testing of the prefilter nodes. In one implementation, the prefilter nodes and the primitive packets, cumulatively form the leaf nodes of the BVH, in that a given a branch of the structure can be replaced by the prefilter nodes and primitive packets and together a testing circuitry performs primitive intersection testing for the BVH. Based on low-precision testing of the triangles grouped within prefilter nodes, triangle data 670 for triangles not rejected by these tests is forwarded to a triangle pipeline for full-precision tests.

On the other hand, within the DGF primitive assembly 660 processes, triangles in a triangle set are tested simultaneously against the ray using low-precision intersection testers. In an implementation, a “hit triangle mask” corresponding to triangles which are not rejected by the low-precision intersection testers, i.e., having an inconclusive intersection result, is forwarded to a triangle pipeline (as triangle data 670). As described herein, a hit triangle mask is a data structure, e.g., including a bit array associated with each candidate triangle. Each bit in the array corresponds to a triangle, indicating whether that triangle intersects with the ray or not. This mask can be efficiently updated during the intersection tests to mark which triangles are hit by the ray. In response to processing the hit triangle mask, the decompressor 600 can further decode data from the DGF node to generate high-precision vertex data (as disclosed in FIG. 5). This high-precision vertex data is used by full-precision intersection tests to further tests the triangles not culled by the low-precision testers. In terms of prefilter nodes, high-precision triangles corresponding to quantized triangles not culled by the low-precision testers are extracted from respective primitive packets (as described in FIG. 3).

In an implementation, intersection test results for the ray against a set of triangles are serialized to a triangle pipeline to perform full-precision intersection tests. Triangles that are culled by low-precision intersection testers are not sent to the triangle pipeline, except for the last test of a ray or the last test of the last ray. The last test must be indicated to the triangle pipeline to allow for flushing of ray results and popping of the DGF node data. In one implementation, triangle data 670 includes ray data that is sent to the triangle pipeline once per ray, and only for a ray that requires full-precision triangle tests. The last ray to be tested will have no corresponding full-precision test to be sent to the triangle pipeline. However, DGF node data still needs to be flushed after processing the last ray, and therefore, a dummy last test transaction can be sent for the last ray to the triangle pipeline, to allow the popping of the DGF node data.

In various implementations, the methods described herein describes ray-triangle intersection pipelines that use parallel low-precision ray-triangle intersection tests to trivially reject large groups of triangles at one time. The triangles are stored in a compressed format which allow generation of low-precision and high-precision triangles from the same data, eliminating data duplication. Further, parallel rejection testing of large groups of triangles enables a ray tracing system to perform many ray-triangle intersections without fetching additional node data. This improves the compute-to-bandwidth ratio of ray traversal and provides a corresponding speedup. The techniques described herein further reduce the area required for bulk ray-triangle intersection by using cheap low-precision pipelines to filter data ahead of the more expensive full-precision pipeline. Bulk ray-triangle intersection, in turn, improves the efficiency of ray tracing, because it removes the need for fine-grained spatial partitioning at the triangle level, resulting in a lower memory footprint and lower memory bandwidth during traversal.

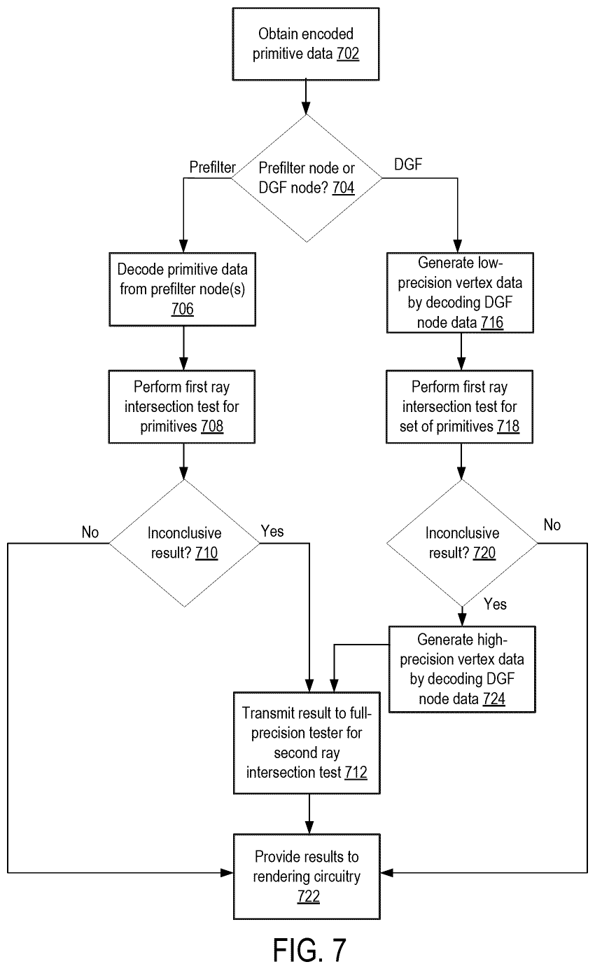

FIG. 7 illustrates a method of decoding primitive data for intersection testing of primitives against rays. As described in the foregoing, primitive data is encoded in one of two ways, i.e., using prefilter nodes and primitive packets (described in FIG. 3) and/or using DGF nodes (described in FIG. 4). Based on which methodology is used to encoding the primitive data, a ray tracing system can accordingly decode the data and perform intersection tests for each primitive.

In one implementation, a ray tracing circuitry receives encoded primitive data for testing primitives against a ray (block 702). The ray tracing circuitry can determine whether the data is encoded using a prefilter node or a DGF node (conditional block 704). In case the data is encoded using prefilter nodes (conditional block 704, “prefilter” leg), the ray tracing circuitry decodes primitive data stored in prefilter nodes (block 706). In an implementation, decoded data corresponding primitives (e.g., triangles) included in the prefilter nodes, is then used to test the primitives against a ray in a first intersection test (block 708). The first intersection test is used as a first pass to distinguish quantized primitives that are intersected or missed definitively by a ray. Further, the first intersection test is performed simultaneously for a single ray against each primitive, e.g., using low-precision intersection testing filters (as described in FIG. 2). The number of low-precision intersection testing filters can be determined based on number of primitives within a prefilter node, amongst other factors.

Based on the result of the first intersection testing, it is further determined whether inconclusive results are obtained for one or more quantized primitives (conditional block 710). If no inconclusive results are obtained (conditional block 710, “no” leg), i.e., conclusive intersection results (hits or misses) are obtained for all primitives that were tested, and the method continues to block 722. At block 722, the results of the intersection tests are provided to a renderer or rendering circuitry. In an implementation, the rendering circuitry uses the result data from the intersection test to calculate the shading and lighting for a specific point on the primitive's surface. This includes evaluating the surface properties (e.g., color, texture, normal) and applying lighting models to determine how the primitive interacts with light sources in the scene. Other implementations are contemplated.

In case there are one or more inconclusive results (conditional block 710, “yes” leg), the primitives for which these inconclusive results are generated are retested against the given ray by a full-precision tester for a second intersection test (block 712). In an implementation, the full-precision tester uses a floating-point mechanism and tests the ray against a given primitive using a precision that is greater than what is used for the first intersection test. Further, in an implementation, a single full-precision tester can be associated with a plurality of low-precision testers operating in parallel, such that a full-precision primitive corresponding to a primitive for which an inconclusive test result is obtained during first intersection test, can be retested by the full-precision tester to definitively ascertain whether the ray hits or misses the primitive. The result of the second intersection test can then be provided to the rendering circuitry (block 722), which can use the result to render an image or a scene.

In one implementation, in case the data is encoded using DGF nodes (conditional block 704, “DGF” leg), low-precision vertex data is generated for each primitive by decoding encoded data stored in a DGF node (block 716). Based on the low-precision vertex data, low-precision intersection tests are performed for a set of primitives simultaneously against a given ray (block 718). Based on the result of the low-precision intersection testing, it is determined whether inconclusive results are obtained for one or more primitives (conditional block 720). If no inconclusive results are obtained (conditional block 720, “no” leg), i.e., conclusive intersection results (hits or misses) are obtained for all primitives that were tested, and the method continues to block 722. At block 722, the results of the intersection tests are provided to a renderer or rendering circuitry.

In case there are one or more inconclusive results (conditional block 720, “yes” leg), high-precision vertex data is generated by further decoding encoded data from the DGF node, e.g., for primitives that presented inconclusive results (block 724). Based on the high-precision vertex data, these primitives are retested against the given ray using a full-precision tester (block 712), and the method continues to block 722. At block 722, the results of the intersection tests are provided to the rendering circuitry.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
generate low-precision vertex data for each primitive of a set of primitives included in encoded primitive data;
simultaneously perform a first ray intersection test for a ray against each primitive using the low-precision vertex data; and
responsive to the first ray intersection test generating an inconclusive intersection result for one or more primitives of the set of primitives:
generate high-precision vertex data for each of the one or more primitives; and
perform a second ray intersection test for the ray against each of the one or more primitives using the high-precision vertex data.

2. The apparatus as claimed in claim 1, wherein the encoded primitive data comprises, for each primitive of the set of primitives:
an anchor position per coordinate of each vertex in a three-dimensional space; and
an offset for each vertex relative to the anchor position.

3. The apparatus as claimed in claim 2, wherein to generate the high-precision vertex data, the circuitry is configured to, for each vertex of each primitive of the one or more primitives:
compute a sum of the offset and the anchor position;
convert the sum to a floating point number; and
apply a scale factor to the converted sum to generate a scaled sum that represents high-precision vertex data for a given vertex.

4. The apparatus as claimed in claim 2, wherein to generate the low-precision vertex data, the circuitry is configured to:
calculate a bounding box for each primitive; and
extract low-precision vertex data corresponding to the bounding box.

5. The apparatus as claimed in claim 4, wherein to generate the low-precision vertex data, the circuitry is further configured to perform a logical bit shift for the offset of each vertex.

6. The apparatus as claimed in claim 1, further comprising graphics processing circuitry configured to render an image based on one or more primitives from the set of primitives, identified by one of the first ray intersection test and the second ray intersection test as being intersected by the ray.

7. The apparatus as claimed in claim 1, wherein the circuitry is configured to perform the second ray intersection test for the one or more primitives individually.

8. A method comprising:
generating, by a ray tracing circuitry, low-precision vertex data for each primitive of a set of primitives included in encoded primitive data;
simultaneously performing, by the ray tracing circuitry, a first ray intersection test for a ray against each primitive using the low-precision vertex data;
responsive to the first ray intersection test generating an inconclusive intersection result for one or more primitives:
generating, by the ray tracing circuitry, high-precision vertex data for each of the one or more primitives; and
performing, by the ray tracing circuitry, a second ray intersection test for the ray against each of the one or more primitives using the high-precision vertex data.

9. The method as claimed in claim 8, wherein the encoded primitive data comprises, for each primitive of the set of primitives:
an anchor position per coordinate of each vertex in a three-dimensional space; and
an offset for each vertex relative to the anchor position.

10. The method as claimed in claim 9, wherein to extract the high-precision vertex data, the method further comprising, for each vertex of each primitive of the one or more primitives:
computing, by the ray tracing circuitry, a sum of the offset and the anchor position;
converting, by the ray tracing circuitry, the sum to a floating point number; and
applying, by the ray tracing circuitry, a scale factor to the converted sum to generate a scaled sum that represents high-precision vertex data for a given vertex.

11. The method as claimed in claim 9, wherein to generate the low-precision vertex data, the method further comprising:
calculating, by the ray tracing circuitry, a bounding box for each primitive; and
generating, by the ray tracing circuitry, low-precision vertex data corresponding to the bounding box by aligning the offset for each vertex with a bit width of an intersection test processing pipeline.

12. The method as claimed in claim 11, wherein to generate the low-precision vertex data, the method further comprising performing, by the ray tracing circuitry, a logical bit shift for the offset of each vertex.

13. The method as claimed in claim 8, further comprising rendering, by a graphics processing circuitry, an image based on one or more primitives from the set of primitives, identified by one of the first ray intersection test and the second ray intersection test as being intersected by the ray.

14. The method as claimed in claim 8, further comprising performing, by the ray tracing circuitry, the second ray intersection test for the one or more primitives individually.

15. A ray tracing system comprising:
a memory configured to store encoded primitive data; and
circuitry configured to:
generate low-precision vertex data for each primitive of a set of primitives included in the encoded primitive data;
simultaneously perform a first ray intersection test for a ray against each primitive using the low-precision vertex data;
responsive to the first ray intersection test generating an inconclusive intersection result for one or more primitives:
generate high-precision vertex data for each of the one or more primitives; and
perform a second ray intersection test for the ray against each of the one or more primitives using the high-precision vertex data.

16. The ray tracing system as claimed in claim 15, wherein the encoded primitive data comprises, for each primitive of the set of primitives:
an anchor position per coordinate of each vertex in a three-dimensional space; and
an offset for each vertex relative to the anchor position.

17. The ray tracing system as claimed in claim 16, wherein to generate the high-precision vertex data, the circuitry is configured to, for each vertex of each primitive of the one or more primitives:
compute a sum of the offset and the anchor position;
convert the sum to a floating point number; and
apply a scale factor to the converted sum to generate a scaled sum, wherein the scaled sum is representative of high-precision vertex data for a given vertex.

18. The ray tracing system as claimed in claim 16, wherein to generate the low-precision vertex data, the circuitry is configured to:
calculate a bounding box for each primitive; and
extract low-precision vertex data corresponding to the bounding box.

19. The ray tracing system as claimed in claim 18, wherein to generate the low-precision vertex data, the circuitry is further configured to perform a logical bit shift for the offset of each vertex, based at least in part on a difference between a bit width of the intersection test processing pipeline and a bit-width of the variable-width offset of each vertex.

20. The ray tracing system as claimed in claim 15, wherein the circuitry is configured to perform the second ray intersection test for the one or more primitives individually.
